(19) United States
(12) Patent Application Publication
(10) Pub. No.: US 2022/0337061 A1
(43) Pub. Date: Oct. 20, 2022

(54) ARTIFICIAL INTELLIGENCE BASED P2P POWER TRADING METHOD AND APPARATUS

(71) Applicant: ELECTRONICS AND TELECOMMUNICATIONS RESEARCH INSTITUTE, Daejeon (KR)

(72) Inventors: SANGKEUM LEE, Daejeon (KR); Yoonmee DOH, Daejeon (KR); Chung-ho LEE, Daejeon (KR); Tae-Wook HEO, Daejeon (KR)

(21) Appl. No.: 17/674,624

(22) Filed: Feb. 17, 2022

(30) Foreign Application Priority Data
Apr. 20, 2021 (KR) 10-2021-0051023

(51) Int. Cl. H02J 3/00; G05B 19/042; H02J 3/38

(52) U.S. Cl. CPC H02J 3/008; G05B 19/042; H02J 3/381; G05B 2219/2639; H02J 2310/14; H02J 2300/24

(57) ABSTRACT

Provided is an artificial intelligence (AI)-based peer-to-peer (P2P) power trading method and apparatus that encourages a household with relatively great power consumption or a household with relatively small power consumption according to a power load pattern for each time period to participate in power trading by optimizing power consumption through AI-based P2P power trading in a cluster including a nanogrid.

### CROSS-REFERENCE TO RELATED APPLICATION

This application claims the benefit of Korean Patent Application No. 10-2021-0051023 filed on Apr. 20, 2021, in the Korean Intellectual Property Office, the entire disclosure of which is incorporated herein by reference for all purposes.

### BACKGROUND

### 1. Field of the Invention

One or more example embodiments relate to a peer-to-peer (P2P) power trading method and a P2P power trading apparatus, and more particularly, to a new type power trading method and apparatus that may perform power trading by analyzing and predicant energy data collected from clusters based on artificial intelligence (AI).

### 2. Description of the Related Art

With the development of technology, a direct current (DC) system is attracting attention again with a new renewable energy source and a distributed power system in a grid market for a high-efficiency system, digital load, and low carbon green growth. A DC nanogrid has small real-time power loss and is suitable for P2P power trading. An existing alternating current (AC) system has difficulty in stabilizing power and has a disadvantage in terms of efficiency compared to the DC system. Currently, efforts to convert AC to DC are expanding the market for electric parts and power equipment to power transmission, power distribution, and each building and internal system. Therefore, an environment for the AC system is insufficient and the existing environment is insufficient for a system and method for power trading of an individual business owner having a PV power generation panel that is a new DC power source.

Currently, most peer-to-peer (P2P) power trading is operated in such a manner that an energy prosumer and an electricity consumer agree on a long-term fair price for power trading and then charge corresponding to surplus power actually supplied from the energy prosumer is offset from electricity bill of the energy prosumer. This P2P power trading limits active market participation of the energy prosumer and has a very limited aspect in terms of sharing information for activation of P2P power trading accordingly.

Accordingly, to activate P2P power trading by strategically inducing actions of an electricity consumer and an energy prosumer, there is a need to design a new P2P power trading mechanism that supports the electricity consumer and the energy prosumer's decision-making on power trading.

To solve this issue, there is a need for a system infrastructure for economic gain by providing optimal P2P power trading and system using artificial intelligence (AI).

### SUMMARY

Example embodiments provide an apparatus and method that may reduce electricity bill of a cluster by predicting photovoltaic (PV) power and load demand according to PV power generation performed by a single cluster including a nanogrid to solve immediate imbalance between the PV power generated through a photovoltaic (PV) panel installed in a specific space and the load demand.

Example embodiments provide an apparatus and method that allows surplus power of PV power self-supplied by a cluster to be sold to another cluster experiencing temporary power shortage by applying a cooperative game model to maximize profits of a producer and a consumer in a process of performing peer-to-peer (P2P) power trading between a plurality of clusters.

Example embodiments provide an apparatus and method that may improve efficiency of P2P power trading in a cluster including a nanogrid by using a gated recurrent unit (GRU) network to estimate predictable load demand and PV power at a future point in time based on a current point in time.

According to an aspect, there is provided a peer-to-peer (P2P) power trading method including collecting photovoltaic (PV) information according to PV power generation from a plurality of clusters that performs the PV power generation through PV panels installed in a specific space; determining each of the plurality of clusters as at least one of a producer and a consumer for P2P power trading between the plurality of clusters based on the collected PV information; transmitting a power packet for surplus power or a power source packet for insufficient power between the plurality of clusters determined as at least one of the producer and the consumer; and performing P2P power trading between the plurality of clusters using a cooperative game model according to the power packet and the power source packet.

The determining as at least one of the producer and the consumer may include analyzing a power load pattern for each time period according to PV power and load demand included in the PV information; and determining each of the plurality of clusters as one of the producer and the consumer based on the power load pattern.

The plurality of clusters, as a group in which a plurality of single clusters each including a nanogrid using a direct current (DC) power source in the specific space is formed, may be interconnected through an interactive network for the P2P power trading.

The transmitting of the power source packet may include transmitting a power packet of the producer for surplus power to a cluster determined as the consumer among the plurality of clusters.

The transmitting of the power source packet may include transmitting a power source packet of the consumer for temporary insufficient power to a cluster determined as the producer among the plurality of clusters.

The performing of the P2P power trading may include determining a current state for PV power and load demand included in the PV information using the power packet and the power source packet; determining a future state for increasing or decreasing power demand for each time unit from the current state; and performing the P2P power trading between the plurality of clusters based on the current state and the future state.

The performing of the P2P power trading may include, when the future state is less than the current state, applying the cooperative game model to the power packet and the power source packet and determining purchasable PV power through a cluster determined as the consumer; and performing the P2P power trading between the plurality of clusters based on the purchasable PV power.

The performing of the P2P power trading may include, when the future state is greater than the current state, applying the cooperative game model to the power packet and the power source packet and determining sellable PV power through a cluster determined as the producer; and performing the P2P power trading between the plurality of clusters based on the sellable PV power.

The performing of the P2P power trading may include signing a contract for P2P power trading between a cluster determined as the producer and a cluster determined as the consumer and performing the P2P power trading between the clusters.

According to another aspect, there is provided a P2P power trading method including collecting photovoltaic (PV) information that includes PV power and load demand according to PV power generation from a plurality of clusters participating in P2P power trading; registering each of the plurality of clusters as at least one of a producer and a consumer for the P2P power trading based on the PV information; sharing a power packet of a cluster registered as the producer and a power source packet of a cluster registered as the consumer between the plurality of clusters; performing scheduling for the P2P power trading between the plurality of clusters using the power packet and the power source packet shared between the plurality of clusters; and performing the P2P power trading between the plurality of clusters based on the scheduling result. The plurality of clusters may be a group in which a plurality of single clusters each including a nanogrid using a direct current (DC) power source in a specific space is formed.

The registering as at least one of the producer and the consumer may include analyzing a power load pattern for each time period according to PV power and load demand included in the PV information and registering each of the plurality of clusters as at least one of the producer and the consumer based on the power load pattern.

The power packet of the producer may include a power amount suppliable through the P2P power trading as an amount that exceeds power consumption of the producer in PV power generated by a PV panel, and the power source packet of the consumer may include a power amount to be supplied through the P2P power trading as an amount less than power consumption of the consumer in the PV power generated by the PV panel.

The performing of the scheduling may include applying a cooperative game model based on the power packet and the power source packet shared between the plurality of clusters and performing scheduling for interaction between supply and demand for PV power.

The performing of the scheduling may include determining PV power to be purchased or PV power to be sold based on a current state and a future state for the PV power and the load demand included in the PV information according to the power packet and the power source packet.

The performing of the P2P power trading may include performing the P2P power trading between the plurality of clusters in consideration of intermittence of a battery that is likely to occur in a process of performing the PV power generation.

According to still another aspect, there is provided a P2P power trading apparatus for performing a P2P power trading method, the P2P power trading apparatus including a processor to configured to collect PV information according to PV power generation from a plurality of clusters that performs the PV power generation through PV panels installed in a specific space, to determine each of the plurality of clusters as at least one of a producer and a consumer for P2P power trading between the plurality of clusters based on the collected PV information, to transmit a power packet for surplus power or a power source packet for insufficient power between the plurality of clusters determined as at least one of the producer and the consumer, and to perform P2P power trading between the plurality of clusters using a cooperative game model according to the power packet and the power source packet.

The plurality of clusters, as a group in which a plurality of single clusters each including a nanogrid using a direct current (DC) power source in the specific space is formed, may be electrically or physically interconnected through an interactive network for the P2P power trading.

The processor may be configured to perform the P2P power trading between the plurality of clusters based on a current state and a future state for PV power and load demand included in the PV information according to the power packet and the power source packet.

According to still another aspect, there is provided a P2P power trading apparatus for performing a P2P power trading method, the P2P power trading apparatus including a processor configured to collect PV information that includes PV power and load demand according to PV power generation from a plurality of clusters participating in P2P power trading, to register each of the plurality of clusters as at least one of a producer and a consumer for the P2P power trading based on the PV information, to share a power packet of a cluster registered as the producer and a power source packet of a cluster registered as the consumer between the plurality of clusters, to perform scheduling for the P2P power trading between the plurality of clusters using the power packet and the power source packet shared between the plurality of clusters, and to perform the P2P power trading between the plurality of clusters based on the scheduling result. The plurality of clusters may be a group in which a plurality of single clusters each including a nanogrid using a DC power source in a specific space is formed.

The processor may be configured to determine PV power to be purchased or PV power to be sold based on a current state and a future state for the PV power and the load demand included in the PV information according to the power packet and the power source packet.

Additional aspects of example embodiments will be set forth in part in the description which follows and, in part, will be apparent from the description, or may be learned by practice of the disclosure.

A P2P power trading method according to example embodiments may solve immediate imbalance between PV power and load demand by predicting the PV power and the load demand according to PV power generation performed by a cluster including a nanogrid with relatively small real-time power loss and may also reduce electricity bill.

A P2P power trading method according to example embodiments may allow surplus power of PV power self-supplied by a cluster to be sold to another cluster experiencing temporary power shortage by applying a cooperative game model to maximize profits of a producer and a consumer in a process of performing P2P power trading between a plurality of clusters.

A P2P power trading method according to example embodiments may improve efficiency of P2P power trading in a cluster including a nanogrid by using a GRU network to estimate predictable load demand and PV power at a future point in time based on a current point in time.

A P2P power trading method according to example embodiments may reduce peak load time at a peak time according to a power load pattern for each time period, dependence of a utility grid, and scheduling delay by performing P2P power trading in a cluster including a nanogrid.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of an overall system to perform artificial intelligence (AI)-based peer-to-peer (P2P) power trading according to an example embodiment;

FIG. 2 illustrates an example of a detailed operation of a P2P power trading apparatus according to an example embodiment;

FIG. 3 illustrates an example of an operation of performing P2P power trading between clusters by applying a cooperative game model according to an example embodiment;

FIG. 4 illustrates an example of an operation of predicting and evaluating PV power and load demand using a gated recurrent unit (GRU) network according to an example embodiment;

FIG. 5 is a flowchart illustrating an example of a P2P power trading method according to an example embodiment; and

FIG. 6 is a flowchart illustrating another example of a P2P power trading method according to an example embodiment.

### DETAILED DESCRIPTION

Hereinafter, example embodiments are described with reference to the accompanying drawings.

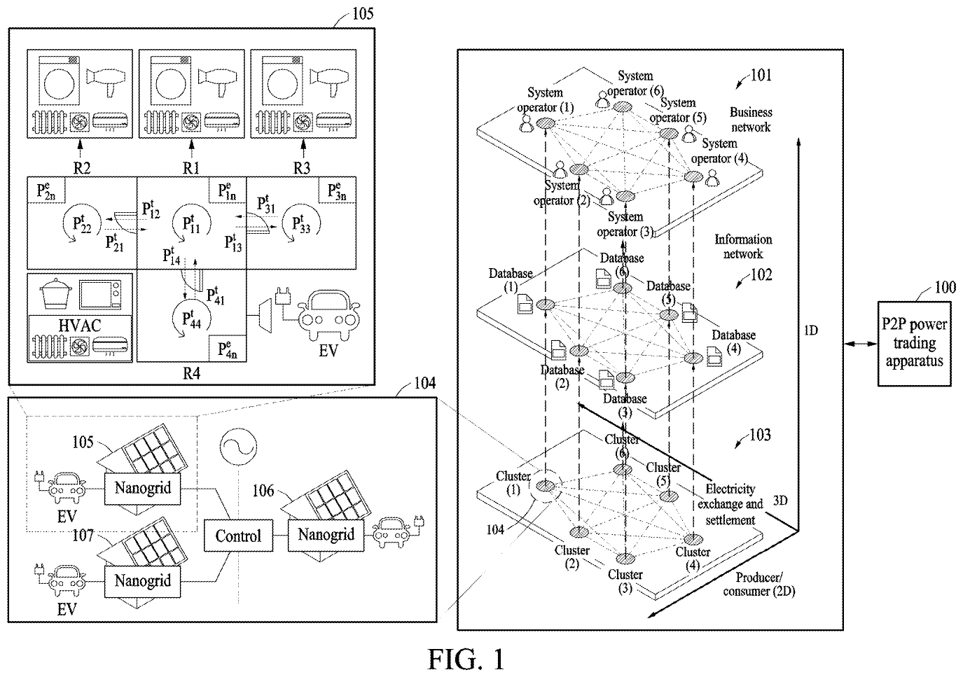

FIG. 1 illustrates an example of an overall system to perform artificial intelligence (AI)-based peer-to-peer (P2P) power trading according to an example embodiment.

Referring to FIG. 1, a P2P power trading apparatus 100 may perform P2P power trading by optimizing power consumption of a cluster through AI-based P2P power trading in the cluster including a nanogrid. The P2P power trading apparatus 100 may perform P2P power trading in the nanogrid using a direct current (DC) power source. Advantages of P2P power trading may include possible real-time analysis and control and high reliability and low power loss according to use of the DC power source.

A single cluster 104 may include three nanogrids (105), (106), (107) and a plurality of clusters 104 may be formed. The plurality of clusters 104 may be electrically or physically interconnected for P2P power trading. A photovoltaic (PV) system represented by three nanogrids, a related electrical device, and a rooftop PV panel may be operated as the cluster 104. A smart meter may monitor, record, and transmit information about load demand and PV power generation. Smart meters communicate with each other through a smart contract protocol for P2P power trading and data collected by the smart meters may be used with other information in the nanogrid.

In P2P power trading proposed herein, a power network 103 may manage PV power generation, power import through a utility grid system, and power trading between the clusters 104. Each cluster 104 may share data related to PV power generation and load demand through an information network 102. P2P power trading between the clusters 104 may be established through a business network 101 based on data of an information network 102 of the smart meter. Therefore, a P2P power trading system may be implemented using a three-layer system including a power network 103, an information network 102, and a business network 101.

A network system architecture is considered for P2P power trading. P2P power trading may have two dimensions, for example, 1D and 2D. 1D of the P2P power trading system relates to three interactive networks including a power network 103, an information network 102, and a business network 101. 2D of the P2P power trading system relates to a role of a peer (e.g., a producer or a consumer). Each cluster 104 may be a producer or a consumer in power trading between the clusters 104 according to PV power generation and related load demand.

Therefore, the P2P power trading apparatus 100 may apply a cooperative game model to maximize public welfare between a buyer and a seller in P2P power trading. The P2P power trading apparatus 100 may consider the future trend of load demand and PV power generation through an artificial intelligence (AI)-based P2P power trading method proposed to improve efficiency of P2P power trading measured by a power ratio.

The P2P power trading apparatus 100 may consider a difference between load demand and PV power generation according to AI-based P2P power trading and, to this end, the P2P power trading apparatus 100 may use a gated recurrent unit (GRU) network. Here, the GRU network may predict future load demand (power demand) and future PV power generation (power supply). The P2P power trading apparatus 100 may reduce peak load at a peak time, dependence of a utility grid, and total scheduling delay as the effect of the P2P power trading method for a nanogrid cluster.

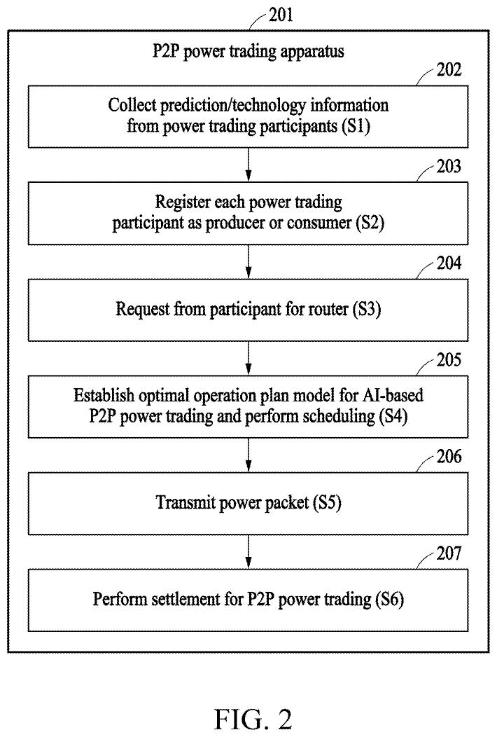

FIG. 2 illustrates an example of a detailed operation of a P2P power trading apparatus according to an example embodiment.

Referring to FIG. 2, a P2P power trading apparatus 201 may apply a power packet transmission model to P2P power trading. The power packet transmission model may run through a series of processes of FIG. 2. The P2P power trading apparatus 201 may perform a new type of power trading by optimizing a use of PV power through cooperative power trading between a producer and a consumer.

In S1 202, the P2P power trading apparatus 201 may collect PV information from participants that desire to proceed with AI-based power trading. The P2P power trading apparatus 201 may collect the PV information according to PV power generation from a plurality of clusters that performs the PV power generation through PV panels installed in a specific space.

In S2 203, the P2P power trading apparatus 201 may register each cluster as a producer or a consumer. For P2P power trading between the plurality of clusters, the P2P power trading apparatus 201 may determine each of the plurality of clusters as at least one of the producer and the consumer. The P2P power trading apparatus 201 may analyze a power load pattern for each time period according to PV power and load demand included in the PV information. The P2P power trading apparatus 201 may determine each of the plurality of clusters as at least one of the producer and the consumer based on the power load pattern.

In S3 204, the P2P power trading apparatus 201 may transmit a power packet of the producer for surplus power or a power source packet of the consumer for insufficient power between the plurality of clusters determined as the producer or the consumer. Here, the power packet of the producer may be transmitted to the consumer connected to an adjacent router, a trading controller may determine the consumer, and an intermediate router may forward the power source packet of the producer.

In S4 205, the P2P power trading apparatus 201 may perform scheduling for the P2P power trading between the plurality of clusters using a cooperative game model according to the power packet and the power source packet. Here, the P2P power trading apparatus 201 may perform scheduling for the P2P power trading using an optimal operation plan model. In detail, with the assumption that a smart meter of a nanogrid cluster controls an operation of all loads and apparatuses, the smart meter may be used to individually capture a voltage signal and a current signal and power consumption of a cluster may be calculated in an individual nanogrid.

The optimal operation plan model may perform multi-purpose optical control for each cluster and a plurality of objective functions of multi-purpose optimization may be variously combined and used depending on a situation. A switching function of schedulable load may be used for multi-purpose optimization and, through this, simultaneous attempts to minimize peak load, grid independence, and total delay of a flexible electronic device. Objective functions may be used as follows.

\textcircled{1} First Objective Function: To Minimize Peak Load (Electricity Cost) of a Cluster

The P2P power trading apparatus 201 may reserve schedulable load and may minimize the electricity cost and the peak load. This peak load movement may be made through schedulable load and P2P trading schedule. For convenience, a non-schedulable load may be used before using the schedulable load, partial power consumption of some loads may correspond to PV power consumption and a remaining part may correspond to grid power consumption.

Self-supplied PV power is used before using a power amount through P2P power trading and, through this, power cost may be minimized through flexible load scheduling by controlling a switching function of the schedulable load.

\textcircled{2} Second Objective Function: To Minimize Grid Dependence for Each Cluster

For an eco-friendly operation of a nanogrid cluster, a self-supply ability of new and renewable energy is becoming more important. Although it may be more economical to consume grid power at a lower rate according to a time-based rate plan, prioritizing the use of PV power may be promoted for the eco-friendly operation. Also, as more energy is locally consumed instead of being transmitted over a long transmission line, it may have a significant influence on reducing fossil energy and improving energy efficiency.

The P2P power trading apparatus 201 may preferentially use the self-supplied PV power to reduce dependence on grid power. Therefore, a portion of load power consumption may be supplied from a solar, that is, PV system and a remaining thereof may be supplied from a grid.

\textcircled{3} Third Objective Function: To Minimize Total Delay for Each Cluster

To minimize load demand at a time in which load greatly increases, a schedulable load needs to be efficiently scheduled. However, excessive scheduling may cause excessive delay, which may cause inconvenience to users. Therefore, to minimize delay through flexible load scheduling is important to improve convenience of daily life. The total delay of a cluster may be minimized.

In the case of local P2P power trading in a cluster based on intermittent security of a battery, the P2P power trading apparatus 201 may perform scheduling in consideration of the following four aspects including (1) demand of a consumer and a prosumer that consume power in a main utility grid, (2) a prosumer that uses self-distributed power generation, (3) P2P power trading in a community, and (4) a battery storage status.

In detail, in the P2P power trading, the consumer and the prosumer may use a utility grid, self-distributed power generation, and power of a battery. The consumer and the prosumer may complement electricity cost and intermittence of self-distributed power generation by strategically using three types of power. Electricity cost for the utility grid and the self-distributed power generation varies over time and the electricity cost becomes lower depending on which type of power is used per time. Therefore, lower electricity cost may be selected through the P2P power trading. Battery storage and the P2P power trading may be performed such that the consumer and the prosumer may achieve lower electricity cost or benefits in the electricity cost that varies over time.

Accordingly, the P2P power trading apparatus 201 may perform scheduling by focusing on interaction between supply and demand in consideration of the above four aspects for P2P power trading.

When power trading and supplied PV power meet the demand, a power demand amount may be set as a power amount for P2P power trading. When the supplied PV power is insufficient for the P2P power trading, the supplied PV power may be set as the power amount for P2P power trading.

Power supplied from each producer for the P2P power trading may be proportional to an excess power amount of each corresponding producer. Also, a power amount demanded by each consumer through the P2P power trading may be proportional to a power amount requested by each consumer.

In S5 206, the P2P power trading apparatus 201 may perform the P2P power trading between the plurality of clusters based on the scheduling result. The P2P power trading apparatus 201 may sign a contract for P2P power trading between a cluster determined as the producer and a cluster determined as the consumer and may transmit and receive power according to the signed contract.

In S6 207, the P2P power trading apparatus 201 may perform the P2P power trading between the clusters by transmitting and receiving power according to the contract and by performing a settlement.

Therefore, the example embodiments may use a DC nanogrid having small real-time power loss as an auxiliary power source for PV power generation according to a structure suitable for P2P power trading, which may lead to reducing electricity bill of a cluster and alleviating imbalance in power consumption between clusters. Also, the example embodiments may predict future for power management for each cluster including three nanogrids and may sell surplus power of self-supplied PV power of a cluster to another cluster experiencing temporary power shortage through P2P power trading. Also, the example embodiments may allow a cluster experiencing temporary power shortage to purchase PV power and to use the same for meeting load demand and reducing the overall delay.

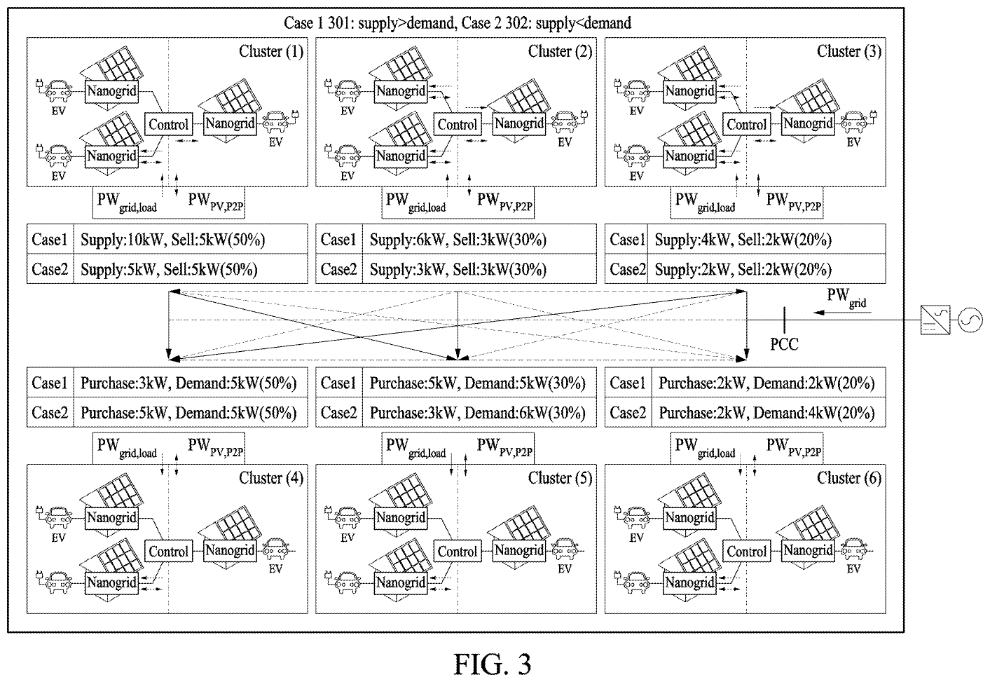

FIG. 3 illustrates an example of an operation of performing P2P power trading between clusters by applying a cooperative game model according to an example embodiment.

Referring to FIG. 3, a P2P power trading apparatus may apply a cooperative game model to AI-based P2P power trading. Here, the cooperative game model may run by focusing on how independent clusters operate together as a single entity to predict future and to minimize electricity bill and a power consumption amount through P2P power trading.

Therefore, purchase or sell of PV power using an AI-based P2P power trading method may be determined herein using the following Equation 1. Equation 1 may be represented as follows.

$${O}_{PV , P 2 P} ( n ) = \{ \begin{matrix}+ 1 ( buy ) & if ( {\sum }_{k = 0}^{K} ( {PW}_{load} ( n + k ) - {PW}_{PV} ( n + k ) ) 〉 ( K + 1 ) {PW}^{max} ) \\ - 1 ( sell ) & if ( {\sum }_{k = 0}^{K} ( {PW}_{load} ( n + k ) - {PW}_{PV} ( n + k ) ) 〈 ( K + 1 ) {PW}^{max} and {PW}_{PV} ( n ) 〉 0 )\end{matrix} \qquad [ Equation 1 ]$$

Referring to Equation 1, O_{PV,P2P}(n) may perform a switching function for AI-based P2P power trading. The P2P power trading method proposed herein may consider a current state and a future state of a PV power generation amount and a load demand amount for P2P power trading. Here, the current state of the PV power generation amount may represent a power amount generated through PV power generation from a PV panel installed in a specific space. The future state of the PV power generation amount may represent a power amount generatable through PV power generation in consideration of intermittence of a battery that is likely to occur in a process of performing the PV power generation. After training appropriate AI, the future state of the PV power generation amount and the load demand amount may be predicted by a GRU network.

PW_{load}(n) and PW_{PV}(n) respectively denote a power consumption amount of all loads in use and a self-supplied PV power amount in an n^{th} time interval. Also, a value of PW_{load}(n) may be a sum of individual power consumption amounts of all loads of a cluster in the n^{th} time interval without reserving schedulable load.

A PV power amount to be purchased may be Σₖ₌₀^{K}PW_{load}(n+k)−PW_{PV}(n+k)−PW^{max} and a PV power amount to be sold may be Σₖ₌₀^{K}(−PW_{load}(n+k)+PW_{PV}(n+k)). The PV power amount to be purchased or sold may be determined by the cooperative game model. PW_{PV,P2P}(n) may be connected to a multi-purpose optimization framework.

A situation in which the P2P power trading apparatus performing P2P power trading by applying the cooperative game model based on Equation 1 may correspond to the following Case 2, and power trading between clusters may be individually performed according to each case.

\textcircled{1} Case 1: (Supply>Demand)

Case 1 301 may correspond to a situation in which a PV power amount supplied from a producer is greater than power requested, that is, demanded by a consumer. The P2P power trading apparatus may perform P2P power trading to sell the PV power amount supplied from the producer. That is, in AI-based P2P power trading, when it is greater than (K+1)PW^{max} of future in P2P power trading, O_{PV,P2P}(n) may perform P2P power trading such that +1 (purchase) may be implemented.

\textcircled{2} Case 2: (Supply<Demand)

Case 2 302 may correspond to a situation in which a PV power amount supplied from a producer is less than power requested by a consumer. The P2P power trading apparatus may perform P2P power trading to purchase surplus power from a producer having surplus power for a PV power amount in a cluster. That is, in AI-based P2P power trading, when it is less than (K+1)PW^{max} of future in P2P power trading and PW_{PV}(n) is a positive number, O_{PV,P2P}(n) may perform P2P power trading such that −1 (sell) may be implemented.

Here, when a role of each cluster in P2P power trading is determined, PV power available for the P2P power trading may be determined based on a ratio of PV power supplied from each producer to total PV power supplied from PW_{PV,P2P}(n) as a producer for P2P power trading. Also, the PV power may be determined based on a ratio of PV power requested by each consumer to total PV power requested by PW_{PV,P2P}(n) as a consumer for P2P power trading according to the cooperative game model in FIG. 3.

In applying the cooperative game model, the P2P power trading apparatus may be used for each of (1) a selling/purchasing method between clusters and (2) selling/purchasing between individual households. Even when the P2P power trading apparatus is used for the selling/purchasing method between individual households, the cooperative game model may be applied in the same manner.

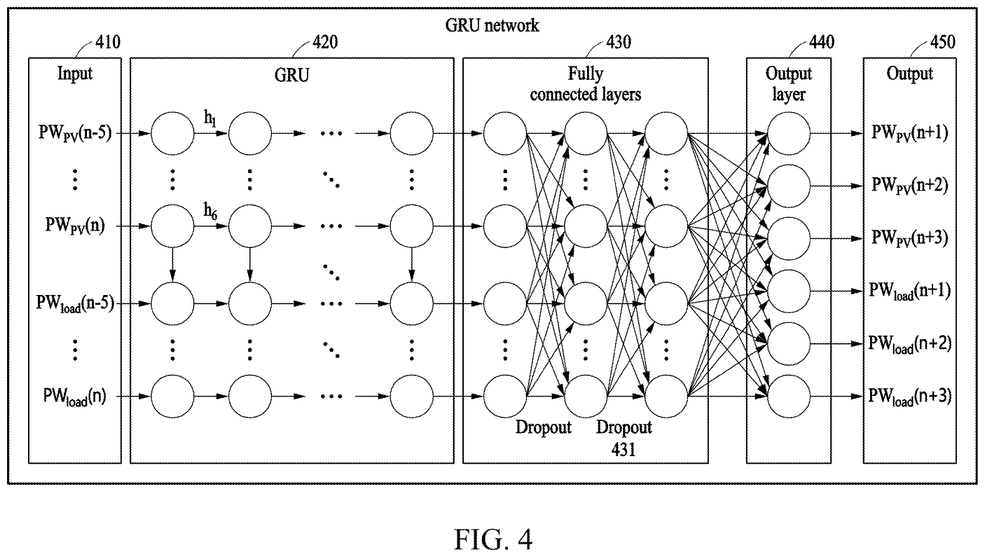

FIG. 4 illustrates an example of an operation of predicting and evaluating PV power and load demand using a GRU network according to an example embodiment.

Referring to FIG. 4, a P2P power trading apparatus may predict PV power and load demand using a neural network model. The neural network model may correspond to at least one of an artificial neural network (ANN) model, a recurrent neural network (RNN) model, a long short term memory (LSTM) model, and a GRU model. The P2P power trading apparatus may use a GRU network that predicts a load demand amount and a PV power generation amount.

Referring to FIG. 4, the GRU network may include six GRU layers 420 and three fully connected layers 430. A dropout 431 refers to a fully connected layer and may prevent overfitting of the GRU network. Here, a number of layers and a data amount used in the optimal GRU layer 420 for an input layer 410 may be determined through trial and error in a P2P power trading process. A number of inputs 410 and a number of outputs 450 of the GRU network may be determined based on a root-mean-squared-error (RMSE) evaluation of a power generation amount by a PV power module and load demand.

Here, the example embodiment may use data of the Korea Meteorological Administration for one year of outdoor temperature synchronized with a PV power generation amount. A heating, ventilating, and air conditioning (HVAC) operation is fundamentally affected by a change in outdoor temperature. Therefore, HVAC operation record may be indirectly affected by AI training.

Therefore, the temporal power consumption of the HVAC system may be directly or indirectly synchronized with the trend of the PV power generation amount and a load demand data set for one year may be acquired from a power management system of a cluster. Each load demand data set may be divided into a learning set (80%) and a verification set (20%), and performance measurement to determine the number of GRU layer 420 and the number of fully connected layers 430 may include a root mean square error (RMSE) of a predicted power amount.

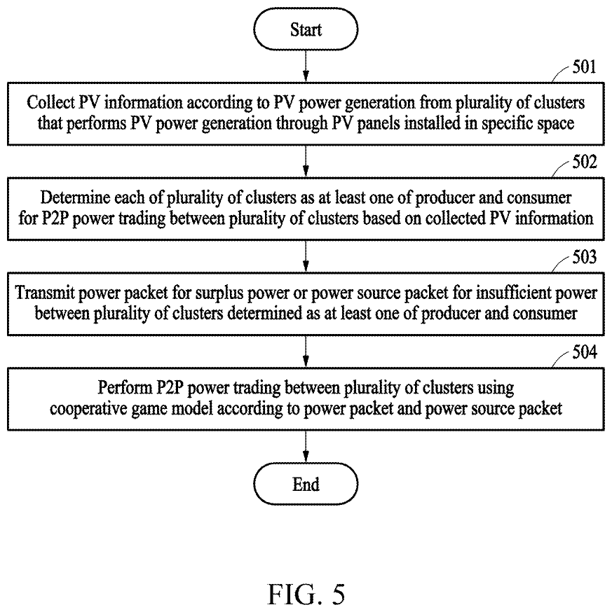

FIG. 5 is a flowchart illustrating an example of a P2P power trading method according to an example embodiment.

In operation 501, a P2P power trading apparatus may collect PV information according to PV power generation from a plurality of clusters that performs the PV power generation through PV panels installed in a specific space. Here, the plurality of clusters refers to a group in which a plurality of single clusters each including a nanogrid using a DC power source in the specific space is formed, and may be interconnected through an interactive network for the P2P power trading.

In operation 502, the P2P power trading apparatus may determine each of the plurality of clusters as at least one of a producer and a consumer for P2P power trading between the plurality of clusters based on the collected PV information. The P2P power trading apparatus may analyze a power load pattern for each time period according to PV power and load demand included in the PV information. The P2P power trading apparatus may determine each of the plurality of clusters as one of the producer and the consumer based on the power load pattern.

In operation 503, the P2P power trading apparatus may transmit a power packet for surplus power or a power source packet for insufficient power between the plurality of clusters determined as at least one of the producer and the consumer. The P2P power trading apparatus may transmit a power packet of the producer for surplus power to a cluster determined as the consumer among the plurality of clusters. The P2P power trading apparatus may transmit a power source packet of the consumer for temporary insufficient power to a cluster determined as the producer among the plurality of clusters.

In operation 504, the P2P power trading apparatus may perform P2P power trading between the plurality of clusters using a cooperative game model according to the power packet and the power source packet. The P2P power trading apparatus may determine a current state for PV power and load demand included in the PV information using the power packet and the power source packet. The P2P power trading apparatus may determine a future state for increasing or decreasing power demand for each time unit from the current state. The P2P power trading apparatus may perform the P2P power trading between the plurality of clusters based on the current state and the future state.

When the future state is less than the current state, the P2P power trading apparatus may apply the cooperative game model to the power packet and the power source packet and may determine purchasable PV power through a cluster determined as the consumer. The P2P power trading apparatus may perform the P2P power trading between the plurality of clusters based on the purchasable PV power.

When the future state is greater than the current state, the P2P power trading apparatus may apply the cooperative game model to the power packet and the power source packet and may determine sellable PV power through a cluster determined as the producer. The P2P power trading apparatus may perform the P2P power trading between the plurality of clusters based on the sellable PV power.

The P2P power trading apparatus may sign a contract for P2P power trading between a cluster determined as the producer and a cluster determined as the consumer. Each cluster may transmit and receive power according to the signed contract and perform settlement according thereto. In this manner, the P2P power trading apparatus may perform the P2P power trading between the clusters.

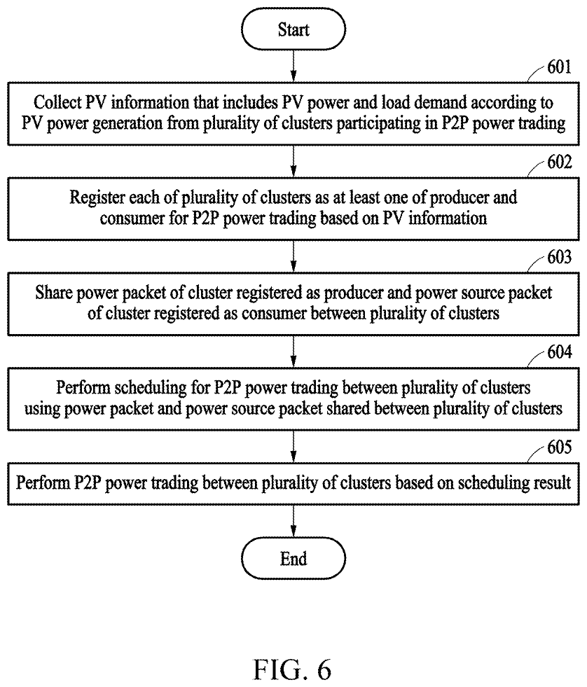

FIG. 6 is a flowchart illustrating another example of a P2P power trading method according to an example embodiment.

In operation 601, a P2P power trading apparatus may collect PV information that includes PV power and load demand according to PV power generation from a plurality of clusters participating in P2P power trading.

In operation 602, the P2P power trading apparatus may register each of the plurality of clusters as at least one of a producer and a consumer for the P2P power trading based on the PV information. The P2P power trading apparatus may analyze a power load pattern for each time period according to PV power and load demand included in the PV information and may register each of the plurality of clusters as at least one of the producer and the consumer based on the power load pattern.

In operation 603, the P2P power trading apparatus may share a power packet of a cluster registered as the producer and a power source packet of a cluster registered as the consumer between the plurality of clusters. The power packet of the producer may include a power amount suppliable through the P2P power trading as an amount that exceeds power consumption of the producer in PV power generated by a PV panel. The power source packet of the consumer may include a power amount to be supplied through the P2P power trading as an amount less than power consumption of the consumer in the PV power generated by the PV panel producer.

In operation 604, the P2P power trading apparatus may perform scheduling for the P2P power trading between the plurality of clusters using the power packet and the power source packet shared between the plurality of clusters. The P2P power trading apparatus may apply a cooperative game model based on the power packet and the power source packet shared between the plurality of clusters and may perform scheduling for interaction between supply and demand for PV power. Also, the P2P power trading apparatus may determine PV power to be purchased or PV power to be sold based on a current state and a future state for the PV power and the load demand included in the PV information according to the power packet and the power source packet.

In operation 605, the P2P power trading apparatus may perform the P2P power trading between the plurality of clusters based on the scheduling result. The P2P power trading apparatus may perform the P2P power trading between the plurality of clusters in consideration of intermittence of a battery that is likely to occur in a process of performing the PV power generation.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A peer-to-peer (P2P) power trading method comprising:
collecting photovoltaic (PV) information according to PV power generation from a plurality of clusters that performs the PV power generation through PV panels installed in a specific space;
determining each of the plurality of clusters as at least one of a producer and a consumer for P2P power trading between the plurality of clusters based on the collected PV information;
transmitting a power packet for surplus power or a power source packet for insufficient power between the plurality of clusters determined as at least one of the producer and the consumer; and
performing P2P power trading between the plurality of clusters using a cooperative game model according to the power packet and the power source packet.

2. The P2P power trading method of claim 1, wherein the determining as at least one of the producer and the consumer comprises:
analyzing a power load pattern for each time period according to PV power and load demand included in the PV information; and
determining each of the plurality of clusters as one of the producer and the consumer based on the power load pattern.

3. The P2P power trading method of claim 1, wherein the plurality of clusters, as a group in which a plurality of single clusters each including a nanogrid using a direct current (DC) power source in the specific space is formed, is interconnected through an interactive network for the P2P power trading.

4. The P2P power trading method of claim 2, wherein the transmitting of the power source packet comprises transmitting a power packet of the producer for surplus power to a cluster determined as the consumer among the plurality of clusters.

5. The P2P power trading method of claim 2, wherein the transmitting of the power source packet comprises transmitting a power source packet of the consumer for temporary insufficient power to a cluster determined as the producer among the plurality of clusters.

6. The P2P power trading method of claim 1, wherein the performing of the P2P power trading comprises:
determining a current state for PV power and load demand included in the PV information using the power packet and the power source packet;
determining a future state for increasing or decreasing power demand for each time unit from the current state; and
performing the P2P power trading between the plurality of clusters based on the current state and the future state.

7. The P2P power trading method of claim 6, wherein the performing of the P2P power trading comprises, when the future state is less than the current state, applying the cooperative game model to the power packet and the power source packet and determining purchasable PV power through a cluster determined as the consumer; and
performing the P2P power trading between the plurality of clusters based on the purchasable PV power.

8. The P2P power trading method of claim 6, wherein the performing of the P2P power trading comprises, when the future state is greater than the current state, applying the cooperative game model to the power packet and the power source packet and determining sellable PV power through a cluster determined as the producer; and
performing the P2P power trading between the plurality of clusters based on the sellable PV power.

9. The P2P power trading method of claim 1, wherein the performing of the P2P power trading comprises signing a contract for P2P power trading between a cluster determined as the producer and a cluster determined as the consumer and performing the P2P power trading between the clusters.

10. A peer-to-peer (P2P) power trading method comprising:
collecting photovoltaic (PV) information that includes PV power and load demand according to PV power generation from a plurality of clusters participating in P2P power trading;
registering each of the plurality of clusters as at least one of a producer and a consumer for the P2P power trading based on the PV information;
sharing a power packet of a cluster registered as the producer and a power source packet of a cluster registered as the consumer between the plurality of clusters;
performing scheduling for the P2P power trading between the plurality of clusters using the power packet and the power source packet shared between the plurality of clusters; and
performing the P2P power trading between the plurality of clusters based on the scheduling result,
wherein the plurality of clusters is a group in which a plurality of single clusters each including a nanogrid using a direct current (DC) power source in a specific space is formed.

11. The P2P power trading method of claim 10, wherein the registering as at least one of the producer and the consumer comprises analyzing a power load pattern for each time period according to PV power and load demand included in the PV information and registering each of the plurality of clusters as at least one of the producer and the consumer based on the power load pattern.

12. The P2P power trading method of claim 10, wherein the power packet of the producer includes a power amount suppliable through the P2P power trading as an amount that exceeds power consumption of the producer in PV power generated by a PV panel, and
the power source packet of the consumer includes a power amount to be supplied through the P2P power trading as an amount less than power consumption of the consumer in the PV power generated by the PV panel.

13. The P2P power trading method of claim 10, wherein the performing of the scheduling comprises applying a cooperative game model based on the power packet and the power source packet shared between the plurality of clusters and performing scheduling for interaction between supply and demand for PV power.

14. The P2P power trading method of claim 10, wherein the performing of the scheduling comprises determining PV power to be purchased or PV power to be sold based on a current state and a future state for the PV power and the load demand included in the PV information according to the power packet and the power source packet.

15. The P2P power trading method of claim 10, wherein the performing of the P2P power trading comprises performing the P2P power trading between the plurality of clusters in consideration of intermittence of a battery that is likely to occur in a process of performing the PV power generation.

16. A peer-to-peer (P2P) power trading apparatus for performing a P2P power trading method, the P2P power trading apparatus comprising:
a processor configured to
collect photovoltaic (PV) information according to PV power generation from a plurality of clusters that performs the PV power generation through PV panels installed in a specific space,
determine each of the plurality of clusters as at least one of a producer and a consumer for P2P power trading between the plurality of clusters based on the collected PV information,
transmit a power packet for surplus power or a power source packet for insufficient power between the plurality of clusters determined as at least one of the producer and the consumer, and
perform P2P power trading between the plurality of clusters using a cooperative game model according to the power packet and the power source packet.

17. The P2P power trading apparatus of claim 16, wherein the plurality of clusters, as a group in which a plurality of single clusters each including a nanogrid using a direct current (DC) power source in the specific space is formed, is electrically or physically interconnected through an interactive network for the P2P power trading.

18. The P2P power trading apparatus of claim 16, wherein the processor is configured to perform the P2P power trading between the plurality of clusters based on a current state and a future state for PV power and load demand included in the PV information according to the power packet and the power source packet.
